(19) United States
(12) Patent Application Publication
(10) Pub. No.: US 2012/0324989 A1
(43) Pub. Date: Dec. 27, 2012

(54) SYSTEM AND METHOD FOR DIAGNOSIS OF ENGINE COMPONENT CONDITION

(75) Inventors: Vipulkumar Patel, Washington, IL (US); Lonny E. Johnson, Peoria, IL (US); Francis L. Clark, III, Pekin, IL (US); Darrel W. Berglund, East Peoria, IL (US)

(73) Assignee: CATERPILLAR INC., PEORIA, IL (US)

(21) Appl. No.: 13/169,817

(22) Filed: Jun. 27, 2011

(51) Int. Cl. G01M 15/08

(52) U.S. Cl. 73/114.16

(57) ABSTRACT

A diagnostic system for an internal combustion engine includes a pressure sensor configured to measure pressure within a combustion cylinder. An electronic controller is configured to receive a pressure signal from the pressure sensor, analyze the pressure signal by at least partially comparing the pressure signal to a predetermined pressure signal, and diagnose a failure of one or more piston ring seal(s), an intake valve, and an exhaust valve of the engine based on a difference between the pressure signal and the predetermined pressure signal.

### TECHNICAL FIELD

This patent disclosure relates generally to internal combustion engines and, more particularly, to systems and methods for diagnosis of the condition of engine components.

### BACKGROUND

Internal combustion engines have many components that can affect the reliable and efficient operation of the engine. Engine operation and performance may be especially affected by the condition of those components that are associated with the engine's combustion cylinders such as intake and exhaust valves, piston rings, head gaskets and the like. Failures can occur for various reasons, such as thermal cycling, fatigue and the like. When such components fail, or their performance is compromised by a less than complete failure, the effects of such failure may not be immediately apparent to the engine's operator. However, such failures may cause a reduction in engine power, loss of sufficient sealing of the engine's combustion cylinder, increased oil consumption, decreased fuel economy, and other effects.

The detection and diagnosis of engine combustion cylinder component failure is a time consuming task because it typically requires engine tear-down or a bore-scope for visual inspection of the interior of a combustion chamber of the engine. This type of diagnosis is typically performed only after the performance of the engine has degraded to an extent where it is apparent, warranting failure diagnosis. When diagnosing engine failures, a technician may examine oil consumption and engine smoke for signs of failure, and may further visually inspect various internal engine components for scoring marks, cracks, breakage, and other modes of failure. In addition to increased oil consumption, for example, when the ring seals on a piston become worn, the oil burning in the cylinders may cause additional engine failures, such as intake or exhaust valves burning out and shattering within the cylinder, pistons seizing within the cylinder bore, and other failures.

Therefore, an early and reliable diagnosis of combustion chamber components of the engine is desired, especially considering that excessive component wear or failure are typically not immediately apparent to an engine operator during normal use of the engine.

### SUMMARY

The disclosure describes, in one aspect, an internal combustion engine having at least one cylinder. The internal combustion engine includes a piston reciprocally disposed within a bore formed in a cylinder block. A crankshaft is connected to the piston such that reciprocal motion of the piston results in rotational motion of the crankshaft. One or more piston ring seals is/are connected to the piston and disposed between the piston and the bore to sealably and slidingly engage the cylinder bore. A cylinder head is disposed to block an open end of the bore such that a combustion chamber is defined within the bore between the piston and the cylinder head. An intake valve selectively opens such that the combustion chamber is fluidly connected with an intake manifold. An exhaust valve selectively opens such that the combustion chamber is fluidly connected with an exhaust collector. A pressure sensor is disposed to sense a cylinder pressure within the combustion chamber and to provide a pressure signal indicative of the cylinder pressure. An electronic controller is configured to receive the pressure signal from the pressure sensor, analyze the pressure signal by at least partially comparing the pressure signal to a predetermined pressure signal, and diagnose a failure of one or more of the piston ring seal(s), the intake valve, and the exhaust valve based on a difference between the pressure signal and the predetermined pressure signal.

In another aspect, the disclosure describes a method for diagnosing failures in engine components. The method includes monitoring a pressure signal indicative of a fluid pressure within a combustion chamber of an internal combustion engine. A timing signal indicative of a rotation of an output shaft of the internal combustion engine is monitored. The pressure and timing signals signal are combined to derive a cylinder pressure trace. The derived cylinder pressure trace is compared with a predetermined cylinder pressure trace, and a component failure is diagnosed based on a difference between the derived and predetermined cylinder pressure traces.

In yet another aspect, the disclosure describes a failure diagnostic system for an internal combustion engine. The system is configured for diagnosing failure or excessive wear of components of the internal combustion engine. The system includes a pressure sensor configured to sense a cylinder pressure within a combustion chamber of the internal combustion engine. The combustion chamber is defined between a piston reciprocally disposed within a bore formed in a cylinder block of the internal combustion engine and a cylinder head disposed to block an open end of the bore. The piston is connected to a crankshaft such that reciprocal motion of the piston results in rotational motion of the crankshaft. The piston further includes one or more piston ring seals connected to the piston. The piston ring seal(s) are disposed between the piston and the bore to sealably and slidingly engage the cylinder bore. The combustion chamber is associated with an intake valve disposed to selectively open such that the combustion chamber is fluidly connected with an intake manifold. The combustion chamber is further associated with an exhaust valve disposed to selectively open such that the combustion chamber is fluidly connected with an exhaust collector. A pressure communication line interconnects the pressure sensor with a controller such that a pressure signal indicative of the cylinder pressure can be provided from the pressure sensor to the controller. The controller is configured to receive the pressure signal from the pressure sensor, analyze the pressure signal by at least partially comparing the pressure signal to a predetermined pressure signal, and diagnose a failure of one or more of the piston ring seal, the intake valve, and the exhaust valve based on a difference between the pressure signal and the predetermined pressure signal.

### BRIEF DESCRIPTION OF THE DRAWINGS

FIG. 1 is a block diagram representation of an internal combustion engine in accordance with the disclosure.

FIG. 2 is a detailed, enlarged view of a combustion cylinder of an engine, which is shown in cross section, in accordance with the disclosure.

FIG. 3 is a block diagram for a control system for diagnosing engine component failure and excessive wear in accordance with the disclosure.

FIG. 4 is qualitative graph showing a pressure trace within a combustion cylinder during a diagnostic test routine in accordance with the disclosure.

FIG. 5 is a flowchart for a method for diagnosing excessive wear and failure of engine components in accordance with the disclosure.

### DETAILED DESCRIPTION

This disclosure relates to internal combustion engines and, more particularly, to the diagnosis of excessive wear or failure of engine components associated with one or more combustion cylinders of the engine. The systems and methods for diagnosing the health of combustion cylinder-related engine components are applicable to any type of engine and are not limited to the embodiments described herein. Accordingly, the present disclosure draws on an exemplary compression ignition or diesel engine for purpose of illustration, but the general concepts underlying the illustrated diagnostic systems and methods are applicable to gasoline engines, natural gas engines, or engines operating with two or more fuels.

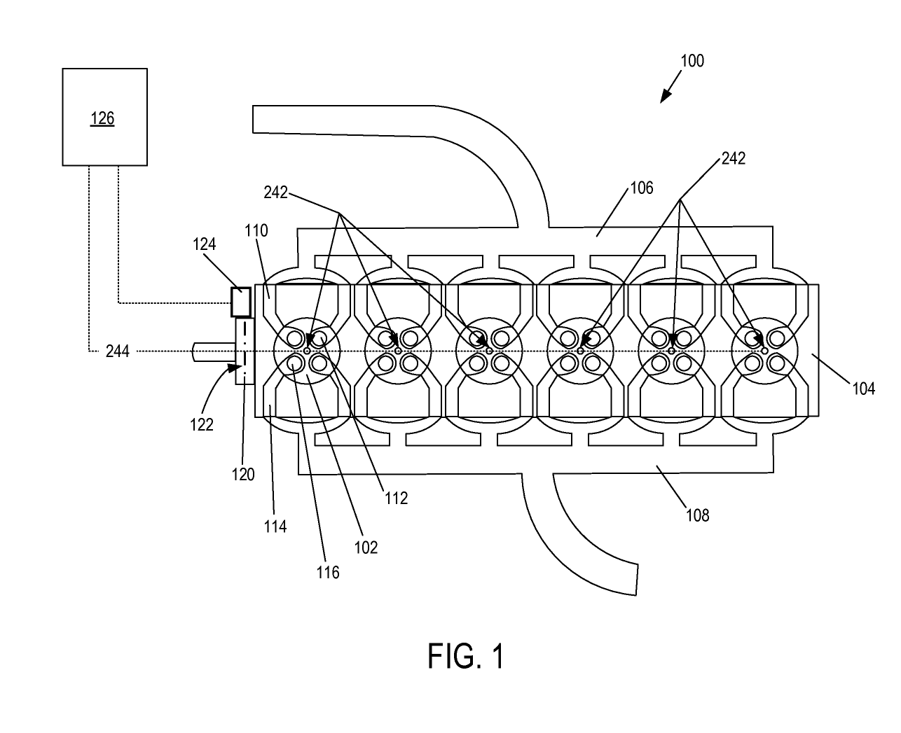

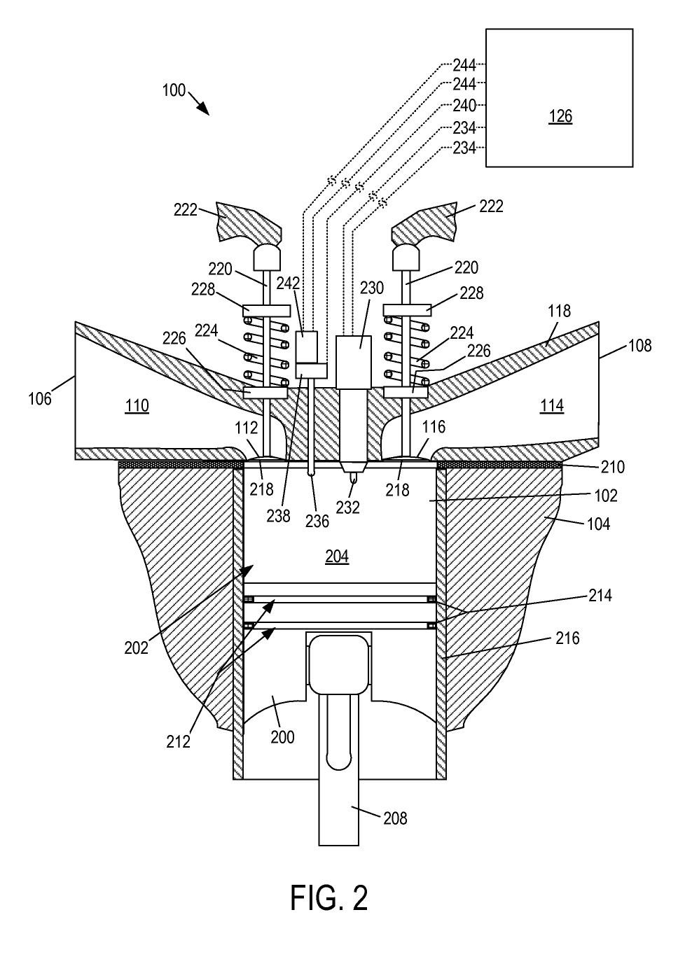

A block diagram of an engine 100 having a plurality of combustion cylinders 102 formed within a cylinder block 104 is shown in FIG. 1. A detailed, enlarged view of a combustion cylinder 102 of the engine 100 (FIG. 1) is shown in cross section in FIG. 2. In the two illustrations of FIGS. 1 and 2, same or similar elements and features are denoted by the same reference numerals for simplicity.

The engine 100 includes an intake manifold 106 and an exhaust collector 108 in fluid communication with the cylinders 102. In the illustrated embodiment, the intake manifold 106 fluidly communicates with each combustion cylinder 102 via intake runners 110 that are fluidly connectable to respective cylinders 102 when a corresponding intake valve 112 is open. Similarly, the exhaust collector 108 is connectable with the cylinders 102 via exhaust runners 114 through exhaust valves 116. As shown in FIG. 2, the intake and exhaust runners 110 and 114 are at least partially formed within a cylinder head 118, but any one of a number of other known engine configurations may be used.

Each cylinder 102 includes a piston 200 that is configured to reciprocate within a bore 202. The portion of the bore 202 between the piston 200 and the cylinder head 118 defines a combustion chamber 204 that is generally sealed when combustion of an air/fuel mixture occurs. Air for the air/fuel mixture, which may further include other fluids such as exhaust gas, is provided to the combustion chamber 204 generally through the intake runners 110. Fuel is provided to the combustion chamber from an injector 230, which in the illustrated embodiment is configured to directly inject fuel into the chamber. In different engines or in alternative embodiments, the injector or another fuel delivery valve may be located elsewhere in the engine such that fuel and air are premixed before being provided to the combustion chamber 204.

When in the combustion chamber 204, the air/fuel mixture is compressed as the piston 200 moves to reduce the volume of the combustion chamber 204 until combustion occurs. Following combustion, exhaust gas remaining in the combustion chamber 204 is evacuated into the exhaust collector 108 through the exhaust valve 116. The reciprocal motion of the piston 200 is transformed to rotary motion of a crankshaft 120 (FIG. 1). The crankshaft 120, which is typically connected to the piston 200 via a connecting rod 208 (FIG. 2), includes indicia or other features 122 that are detectable by a crankshaft position sensor 124 (FIG. 1) during operation. Information or signals from position sensor 124 are provided to an electronic controller 126. The quality of the sealed containment of the air/fuel combustion mixture within the combustion chamber 204 is known to directly affect the efficiency and quality of engine operation.

In the illustrated embodiment, various engine components contribute to the various sealing functions provided to the combustion chamber 204 during operation. As is best shown in FIG. 2, a head gasket 210 is sealably positioned along the interface between the cylinder block 104 and the cylinder head 118 such that leakage of fluids is minimized along that interface. The piston 200 includes a plurality of piston ring grooves 212 (two shown) along its outer periphery. Each piston ring groove 212 includes a piston ring seal 214 that radially, slidably, and generally sealably engages the inner wall of the bore 202. Although the bore 202 against which the ring seals 214 slide may be formed directly into the cylinder block 104, the engine 100 is shown in FIG. 2 to include a cylinder sleeve 216 within which the bore 202 is defined.

The intake and exhaust valves 112 and 116 are poppet valves forming seats that fluidly block the intake and exhaust runners 110 and 114, respectively, from the combustion chamber 204 when the valves 112 and 116 are closed. Accordingly, each valve 112 and 116 forms a poppet portion 218 that sealably engages a corresponding seat formed in the cylinder head 118. Each valve 112 or 116 includes a stem portion 220 connected to the poppet portion 218. The stem portion 220 includes a ball and socket connection arrangement with a valve bridge 222 (partially shown). Rocking motion of the bridge 222 causes the opening and closing of the valves 112 and 116, as is known. A spring 224 disposed between a guide 226 and a retainer 228 biases the valve 112 or 116 towards a closed position. Although one configuration for the structure, installation and actuation of the intake and exhaust valves 112 and 116 is shown herein, any other appropriate configuration may be used.

In the illustrated embodiment, a fuel injector 206 includes a nozzle tip 232 disposed in fluid communication with the combustion chamber 204 and configured to selectively inject an amount of fuel therein during operation. The fuel injected by the tip 232 mixes with air found in the combustion chamber 204 to form the air/fuel mixture that is compressed before combustion in the known fashion. The injection of fuel from the injector 230 can be accomplished by providing an appropriate injection signal to the injector from the controller 126 via injector communication conduits 234.

In the particular exemplary embodiment shown in FIG. 2, the engine 100 is a diesel engine. Accordingly, when operating or starting the engine under certain conditions, such as cold start conditions, a glow plug 236 can be disposed in fluid contact with the combustion chamber 204 to warm the air/fuel mixture in the combustion chamber 204 and thus aid in initiating combustion. More specifically, the glow plug 236, which is an electrically operated heater, can provide thermal energy to the air/fuel mixture in the combustion chamber 204, thus reducing the flash point of the mixture to aid in engine operation, especially under cold start engine operating conditions. The glow plug 236 as shown is connected to an actuator 238 that activates the device in response to a signal from the controller 126 that is provided via a glow plug communication line 240.

In the illustrated embodiment, the presence and position of the glow plug 236 in direct contact with the combustion chamber 204 is exploited to provide an input indicative of the pressure of fluids within the combustion chamber 204. In this way, the glow plug 236 is slidably but sealably connected to the cylinder head 118 and communicates forces to a pressure sensor 242, which in the illustrated embodiment is connected on an external side of the glow plug 236. The pressure sensor 242 may be constructed by any appropriate and known method, such as those including piezoelectric elements, optical devices, and others. The pressure sensor 242 may be connected in direct fluid communication with the combustion chamber 204 and, in the illustrated embodiment, is further in direct contact with engine structure surrounding the combustion chamber such that vibrations present therein may be transferred to the sensor 242.

Regardless of the type and positioning employed for the installation of the pressure sensor 242, a signal indicative of the pressure, in real time, of fluids within the combustion chamber is provided to the electronic controller 126 via pressure signal communication lines 244. Certain sensor configurations, such as those sensors using piezoelectric elements, may be further configured to provide a signal indicative of vibration experienced by the sensor, for example, when intake or exhaust valves close, during engine operation.

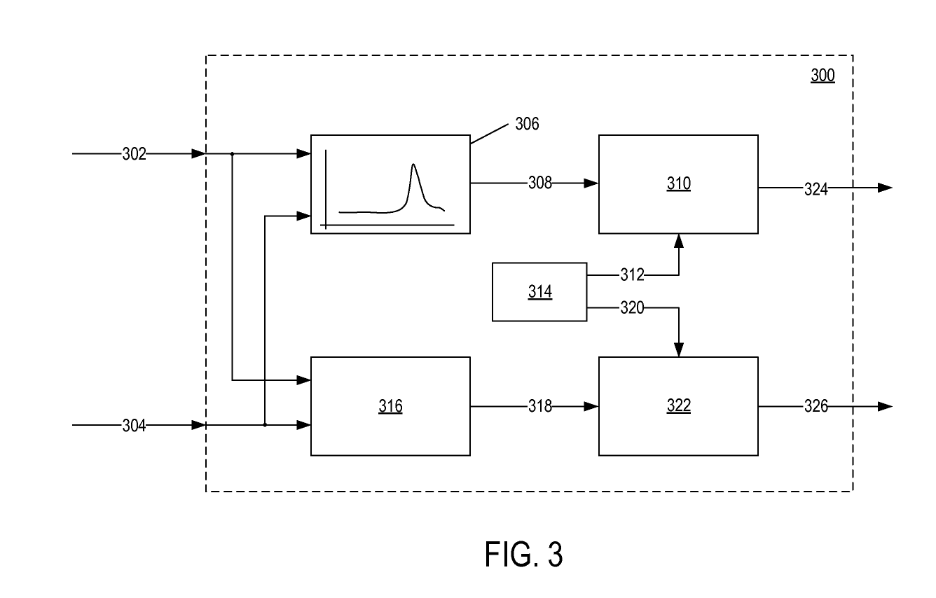

The electronic controller 126 may be a single controller or may include more than one controller disposed to control various functions and/or features of a machine. For example, a master controller, used to control the overall operation and function of a vehicle, machine or stationary application may be cooperatively implemented with an engine controller used to control the engine 100. In this embodiment, the term “controller” is meant to include one, two, or more controllers that may be associated with the engine 100 and that may cooperate in controlling various functions and operations. The functionality of the controller, while shown conceptually in FIG. 3 to include various discrete functions for illustrative purposes only, may be implemented in hardware and/or software without regard to the discrete functionality shown. Accordingly, various interfaces of the controller are described relative to components of the engine in the block diagram of FIG. 3. Such interfaces are not intended to limit the type and number of components that are connected.

A block diagram for a control 300 configured to monitor and diagnose engine component failure, or alternatively warn of unacceptable component wear, is shown in FIG. 3. The control 300 is configured to receive various inputs and provide various outputs during operation, and may be operating within the controller 126 as shown in FIG. 1. Relevant to the present disclosure, certain inputs and outputs are discussed, but additional and/or different inputs and outputs than those discussed may be used. In the illustrated embodiment, a cylinder pressure signal 302 indicative of the pressure, in real time, from within at least one engine cylinder is provided to the control 300. As previously discussed, for example, relative to engine 100 (FIG. 1), more than one cylinder 102 may be present. Although a single cylinder pressure signal 302 is shown in FIG. 3, it is contemplated that more than one input may be present when an engine includes more than one cylinders having instrumentation for monitoring pressure as generally described herein.

The control 300 further receives a timing signal 304 that is indicative of the rotation of the engine. For example, timing signal 304 may be provided by the sensor 124 (FIG. 1) that is associated with the engine crankshaft or another sensor that is similarly associated with another rotating engine component, such as a camshaft, that can provide signals indicative of the angular position of the engine's crankshaft or a derivative, over time, during engine rotation. It is noted that the timing signal 304 may be operating regardless of whether the engine is operating to produce power or whether the engine is motored, for example, by use of a starter motor, when the engine is decelerating without fuel being provided to the engine's cylinders or, in accordance with one embodiment, when fuel is selectively cut off to at least one cylinder during engine operation such that a diagnostic test may be conducted.

The cylinder pressure signal 302 and the timing signal 304 are provided to a pressure trace monitor 306. The pressure trace monitor 306 may acquire pressure and timing data to provide a pressure trace graph for the cylinder being monitored. In the known fashion, a pressure trace graph may be visually represented by a curve comprising points plotted against a vertical axis indicative of pressure and a horizontal axis indicative of angle of crankshaft position. When pressure information is plotted over a range of angles, the resulting points can be shown as a curve. The pressure trace monitor 306 provides cylinder trace information signals 308 to pressure trace comparator 310. The cylinder trace information signals 308 may be provided in any appropriate or desired format, such as digital or analog data, numerical or visual format, and so forth, and are not limited to a pressure trace curve.

The pressure trace comparator 310 is provided with one or more predetermined pressure traces 312 for each engine cylinder. As used herein, pressure trace means a pressure signal acquired over time and may or may not include information about engine timing. The predetermined pressure traces 312 are provided to the comparator 310 from a memory device 314. The pressure traces in the memory device 314 may be generic for any particular engine cylinder configuration or may alternatively be tailored for a particular engine. In the illustrated embodiment, at least one cylinder pressure trace, which includes a predetermined or baseline curve of cylinder pressure points plotted against crankshaft angle, is acquired when the engine is first manufactured and operated such that all cylinder components such as piston ring seals, valves, etc., are in a new condition. This baseline pressure trace is stored in non-volatile memory components within the pressure trace memory device 314. Additional predetermined pressure traces can be acquired at each engine startup or at other predetermined intervals of engine service.

The cylinder trace information signals 308 are compared to the predetermined pressure traces 312 in the comparator 310 during operation to determine whether any variation is present between the cylinder pressure trace determined at the pressure trace monitor 306 and any of the predetermined pressure traces 312. The comparison operation may be accomplished by any suitable means, such as a graphical, numerical, and/or computational operations. Moreover, one or more types of comparison may be conducted. For example, a point-to-point comparison may monitor the divergence of non-outlying pressure values to their corresponding baseline values for any given crankshaft angle. In this type of comparison, the comparator 310 may further determine the angle at which a maximum or peak pressure occurs, as well as compare the peak pressure value at that angle. When the cylinder is operated in a four stroke combustion cycle, i.e., in the presence of a fuel/air mixture that is combusted within the cylinder at an appropriate stroke, the peak pressure may be used as an indication of the timing and amount of fuel that is injected within the cylinder to diagnose the operation of a fuel injector. When the cylinder is motored without fuel added, the peak pressure may be used as an indication of the condition of the cylinder sealing components, such as the intake and exhaust valves, the head gasket, piston rings, and the like. In one embodiment, the fuel supply to individual cylinders may be conducted on those cylinders.

Additional comparisons based on measurements of monitored or derived parameters can be performed to determine various other failure modes. Accordingly, the pressure and timing signals 302 and 304 are provided to a monitoring module 316. The monitoring module 316, which is shown separate in FIG. 3 but which may alternatively be integrated with the pressure trace monitor 306, is configured to determine parameters 318 that are derived from the pressure and timing signals 302 and 304.

In the illustrated embodiment, the monitoring module 316 is configured to determine or monitor the heat release rate in the cylinder when the cylinder is operating in the presence of combustible fuel. The monitoring module 316 is further configured to monitor the pressure rise rate within the cylinder both when the cylinder contains combusting air/fuel mixtures as well as when the cylinder is pressurized without combustion. In such instances, i.e., when the cylinder is pressurized without fuel, the engine is caused to turn, for example, by use of a starter motor or by a transmission connected to and turning the engine when a vehicle is decelerating, the monitoring module 316 is configured to determine the cylinder's indicated mean effective pressure (IMEP). The condition when the engine is turned without combustion is commonly referred to as engine motoring. When all or at least a subset of the engine's cylinders are motored, the IMEP represents the average pressure within the cylinder over a compression cycle in the combustion chamber of the engine. Further, when the engine is motored, any unusual noise that is present in the pressure signal 302 and other parameters are monitored in the monitoring module 316.

Each of these parameters 318, which are derived from the pressure and timing signals 302 and 304, is compared to a predetermined threshold 320 or other value that is provided from the memory device 314 in a derived parameter comparator 322. The derived parameter comparator 322 is configured to receive the various parameters 318, which are collectively shown as a single line in FIG. 3 for simplicity, with their corresponding thresholds 320 by any appropriate computational or information processing means.

The pressure trace comparator 310 provides a pressure trace diagnostic signal 324 and the derived parameter comparator 322 provides a derived parameter diagnostic signal 326, each of which is indicative of the operational status and wear condition of a variety of engine components. For example, failed or worn piston ring seals can be detected when the diagnostic signals 324 and/or 326 indicate that the peak cylinder pressure is lower than expected or that the pressure rise rate within the cylinder is lower than expected. Changes in peak pressure, heat release rate, and/or pressure rise rate can be an indication of a failure in the fuel injection system of the cylinder being monitored. More specifically, high peak cylinder pressures and/or high total heat release determinations can be an indication of excessive fueling such as what can occur when an injector nozzle opening has worn. The diagnostic signals 324 and 326 are provided to other components and systems such that proper indications of potential failure or wear can be provided to service personnel and engine operators as appropriate.

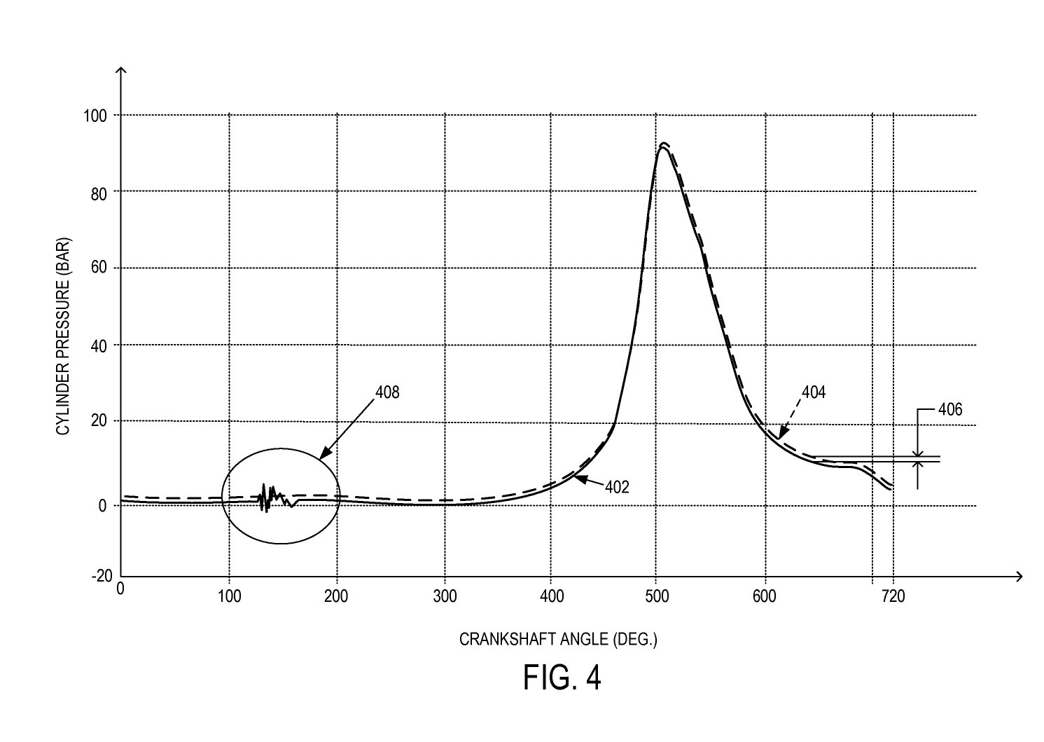

In one exemplary failure effect, an unusual signal noise occurring at a particular crankshaft angle range was detected as an indication of failure in the intake or exhaust valve actuation mechanism. A sample cylinder pressure trace 402 (shown in solid line) that has been overlaid onto a baseline cylinder pressure trace 404 (shown in dashed line) for purpose of illustration and discussion is shown in the graph of FIG. 4. In reference to FIG. 4, it can be seen that the sample trace 402 and baseline trace 404 have generally the same shape, but there are minor differences that the control 300 can detect such that the condition of various engine components can be determined. More specifically, the sample trace 402 is lower by a small amount or offset 406, as shown. The offset 406 may be attributed to blow-by, which is caused by worn piston ring seals. The offset 406 may be quantified by the control 300 as previously described and compared to a threshold of acceptable blow-by. Of course, the information provided in FIG. 4 is exemplary and has been simplified and enhanced for an understanding of the discussion of FIG. 4. Accordingly, the extent and location of the offset 406 and the other features illustrated may differ from the illustration of FIG. 4 depending on the age, wear, and other aspects of the components of a particular engine.

As is further shown in FIG. 4, an unusual trace was acquired in a region 408, which is shown circled in the graph, that lies between 100 and 200 degrees of crankshaft rotation. The pressure trace 402 in the region 408 exhibits rapid pressure fluctuations that coincide with the range of crankshaft angles over which one or more intake valves associated with the monitored cylinder are expected to open, such that air can be admitted into the cylinder. Depending on noise intensity, the noise in region 408, or a similar type of noise occurring where the intake valve(s) close or where exhaust valve(s) associated with the cylinder open or close, is indicative of failure, excessive wear, or a developing failure in the corresponding valve actuation mechanism. For the noise shown in the region 408, for example, it was determined when the test engine was torn down that the noise had been created by a broken bridge and rocker arm that activate the intake valve. After those components had been replaced, a follow-up test was run in which the noise observed in the pressure signal was no longer present.

As previously discussed, the particular shape of the noise in region 408 can be viewed to represent vibration caused by the broken bridge and rocker arm. Thus, the specific shape of the pressure trace within range 408 or an equivalent may look substantially different than what is shown in terms of the location and number of peaks and valleys, the amplitude of the noise, and other features. For purpose of diagnosing failure, the detection of noise can be accomplished by any appropriate method, such as monitoring the exceeding of a threshold value, or monitoring of the pressure signal for indications of sudden swings in the sensed pressure value. Another method that can be employed is a frequency analysis of the pressure fluctuation.

### INDUSTRIAL APPLICABILITY

The present disclosure is applicable to internal combustion engines of any type and for any application. In the illustrated embodiments, the engine described is shown as having a pressure sensor associated with each engine cylinder. In alternative embodiments, depending on the type of engine component wear that is desired to be monitored, pressure sensors can be used in one or, at least, in fewer than all engine cylinders. For example, for an engine having uniform wear performance in the various piston ring seals of the engine's cylinders, if the wear in cylinders is a parameter of interest, then a single pressure sensor may be installed in a representative engine cylinder for monitoring of cylinder ring seal wear. Alternatively, although sensors are shown as permanent engine fixtures in the described embodiment, the sensors may be installed for each test and otherwise removed from the engine during normal service.

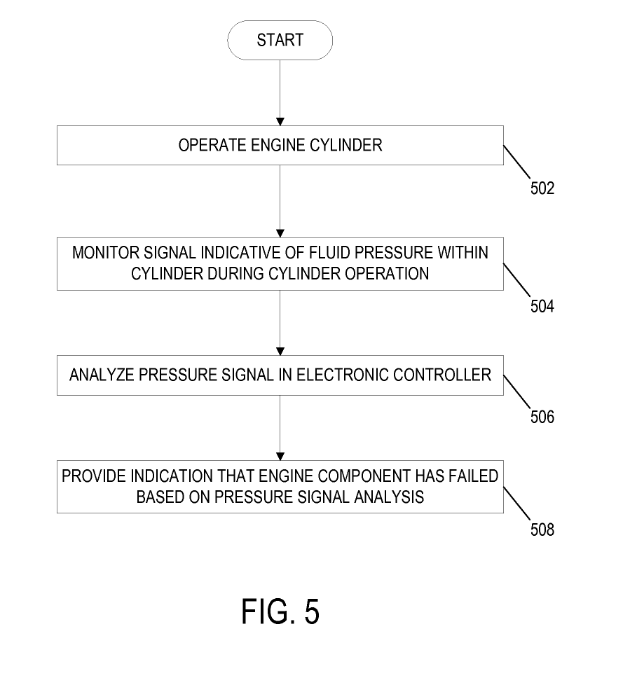

The systems and methods described herein are applicable for various engine diagnostic tests that can be performed both in a service environment as well as during normal operation of the engine. A flowchart for a method of diagnosing the condition of various engine components is shown in FIG. 5. At the onset of a diagnostic procedure, the cylinder is operated at 502 by causing a piston to reciprocate within a bore of the engine. Cylinder operation may occur during normal engine operation such that, generally, an air/fuel mixture is pressurized and combusted within the cylinder. Alternatively, the cylinder may be operated without combustion, such as when the engine is motored or when the engine is decelerating with the fuel supply to the cylinder having been cut off. While the cylinder is operated, a signal indicative of fluid pressure within the cylinder may be monitored at 504. The cylinder pressure may be analyzed at 506 to determine the condition of various engine components that are associated with the cylinder. The analysis may provide an indication at 508 that an engine component has failed, will fail, has worn excessively, and/or provide other indications relative to the condition of various engine components.

The monitoring at 504 may occur while the engine is operating normally, i.e., when the air/fuel mixture is provided to the cylinder being monitored for combustion, or alternatively while the engine is motored. In this way, an engine may undergo an invasive testing procedure periodically or at each engine startup. In such conditions, the initiation of fuel injection while the engine is turned by a starter may be delayed such that motoring cylinder pressure data may be acquired and analyzed before the engine starts. Alternatively, the fuel supply to one or more engine cylinders may be interrupted during engine operation to motor those cylinders under the power produced by the remaining engine cylinders, such that data from those cylinders can be acquired. In the event a failure is detected, depending on the determination of which engine component has failed, starting of the engine may be aborted to avoid additional failures. In certain instances, such as when wear in piston ring seals is detected, the engine may be allowed to start but a controller monitoring the state of engine components as described herein may provide a notification or alarm signal to the engine operator indicating that engine service is required.

In one optional embodiment, depending on the type of condition that is diagnosed, the controller may allow the engine to operate but at a reduced power output mode such that further damage to engine components may be avoided while the engine is scheduled for service or repair. In another optional embodiment, an intrusive test during which the fuel provided to one or more cylinders is cut off during engine operation may be carried out. In such embodiment, fuel would continue to be supplied as normal to other cylinders while the particular cylinder cycling without fuel is motored. In this way, the motoring pressure can be monitored at different conditions. As a refinement to this embodiment, the engine may be run at a specific more than one operating condition such that cylinder operation can be examined under different operating conditions.

It will be appreciated that the foregoing description provides examples of the disclosed system and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

We claim:

1. An internal combustion engine having at least one cylinder, a piston reciprocally disposed within a cylinder bore formed in a cylinder block, a crankshaft connected to the piston such that reciprocal motion of the piston results in rotational motion of the crankshaft, one or more piston ring seals connected to the piston and disposed between the piston and the cylinder bore to sealably and slidingly engage the cylinder bore, a cylinder head disposed to block an open end of the cylinder bore, a combustion chamber defined within the cylinder bore between the piston and the cylinder head, an intake valve disposed to selectively open such that the combustion chamber is fluidly connected with an intake manifold, and an exhaust valve disposed to selectively open such that the combustion chamber is fluidly connected with an exhaust collector, the engine further comprising;
a pressure sensor disposed to sense a cylinder pressure within the combustion chamber and provide a pressure signal, which is indicative of the cylinder pressure; and
an electronic controller configured to receive the pressure signal from the pressure sensor, analyze the pressure signal by at least partially comparing the pressure signal to a predetermined pressure signal, and diagnose a failure of one or more of the piston ring seal(s), the intake valve, and the exhaust valve based on a difference between the pressure signal and the predetermined pressure signal.

2. The internal combustion engine of claim 1, further comprising a fuel injector configured to inject fuel into the combustion chamber.

3. The internal combustion engine of claim 2, wherein the fuel injector is configured to inject fuel at an injection timing, and wherein the electronic controller is further configured to determine the injection timing based on the pressure signal and diagnose a failure of the fuel injector.

4. The internal combustion engine of claim 1, wherein the electronic controller is further configured to analyze the pressure signal when the at least one cylinder of the internal combustion engine is motoring.

5. The internal combustion engine of claim 1, further comprising a timing sensor configured provide a timing signal, which is indicative of the rotational motion of the crankshaft to the electronic controller.

6. The internal combustion engine of claim 5, wherein the electronic controller is configured to diagnose the failure further based on the timing signal.

7. The internal combustion engine of claim 5, wherein an analysis of the pressure signal includes a compilation of a cylinder pressure trace based on the pressure signal and the timing signal.

8. The internal combustion engine of claim 1, wherein the pressure signal is further indicative of a vibration occurring in an engine component associated with the at least one cylinder.

9. The internal combustion engine of claim 1, wherein the electronic controller is configured to diagnose the failure when the difference between the pressure signal and the predetermined pressure signal exceeds a threshold value.

10. A method for diagnosing failures in engine components, comprising:
monitoring a pressure signal, which is indicative of a fluid pressure within a combustion chamber of an internal combustion engine;
monitoring a timing signal, which is indicative of a rotation of an output shaft of the internal combustion engine;
combining the pressure and timing signals signal to derive a derived cylinder pressure trace;
comparing the derived cylinder pressure trace with a predetermined cylinder pressure trace; and
diagnosing a component failure based on a difference between the derived and predetermined cylinder pressure traces.

11. The method of claim 10, wherein monitoring the pressure signal and the timing signal is accomplished when the combustion chamber is motored in the absence of combustion.

12. The method of claim 11, wherein the difference between the derived and predetermined pressure traces includes monitoring for a noise in the pressure signal occurring at an angle of engine rotation that coincides with an opening or closing of an intake valve and an exhaust valve, and wherein a presence of the noise in the pressure signal occurring at an angle coinciding with the opening or closing of the intake valve or the exhaust valve is diagnosed as a valve actuation mechanism failure.

13. The method of claim 10, wherein monitoring the pressure signal is further indicative of a vibration occurring in an engine component that is associated with the combustion chamber.

14. The method of claim 10, wherein monitoring the pressure signal includes determining a peak cylinder pressure, and wherein a magnitude and a timing of the peak cylinder pressure is used for diagnosing a fuel injection system failure.

15. The method of claim 10, wherein the predetermined cylinder pressure trace is acquired when the engine components are in a new and unworn condition, and stored in a memory storage device, wherein the comparison between the derived and predetermined cylinder pressure traces includes retrieving the predetermined cylinder pressure trace from the memory storage device.

16. A failure diagnostic system for an internal combustion engine, the system configured for diagnosing failure or excessive wear of components of the internal combustion engine, the system comprising:
a pressure sensor configured to sense a cylinder pressure within a combustion chamber of the internal combustion engine;
the combustion chamber defined between a piston reciprocally disposed within a bore formed in a cylinder block of the internal combustion engine and a cylinder head disposed to block an open end of the bore, the piston being connected to a crankshaft such that reciprocal motion of the piston results in rotational motion of the crankshaft, the piston further having one or more piston ring seals connected to the piston and disposed between the piston and the bore to sealably and slidingly engage the bore, the combustion chamber being associated with an intake valve disposed to selectively open such that the combustion chamber is fluidly connected with an intake manifold and with an exhaust valve disposed to selectively open such that the combustion chamber is fluidly connected with an exhaust collector;
a pressure communication line interconnecting the pressure sensor with a controller such that a pressure signal, which is indicative of the cylinder pressure, is provided from the pressure sensor to the controller;
the controller being configured to:
receive the pressure signal from the pressure sensor,
analyze the pressure signal by at least partially comparing the pressure signal to a predetermined pressure signal, and
diagnose a failure of one or more of the piston ring seal, the intake valve, and the exhaust valve based on a difference between the pressure signal and the predetermined pressure signal.

17. The failure diagnostic system of claim 16, further comprising a timing sensor adapted to sense a rotational motion of the internal combustion engine and provide a timing signal to the controller.

18. The system of claim 17, wherein the controller is configured to diagnose the failure further based on the timing signal.

19. The system of claim 18, wherein the analysis of the pressure signal in the controller includes a compilation of a cylinder pressure trace based on the pressure signal and the timing signal.

20. The system of claim 18, wherein the controller is further configured to diagnose the failure when the difference between the pressure signal and the predetermined pressure signal exceeds a threshold value.
